(19) United States
(12) Patent Application Publication
(10) Pub. No.: US 2021/0055394 A1
(43) Pub. Date: Feb. 25, 2021

(54) SYSTEM AND METHODS FOR REDUCING NOISE IN SENSOR MEASUREMENTS IN CONNECTED LIGHTING SYSTEMS

(71) Applicant: SIGNIFY HOLDING B.V., EINDHOVEN (NL)

(72) Inventors: Abhishek MURTHY, EINDHOVEN (NL); Sirisha RANGAVAJHALA, EINDHOVEN (NL)

(21) Appl. No.: 16/959,387

(22) PCT Filed: Dec. 28, 2018
(86) PCT No.: PCT/EP2018/097123

§ 371 Date: Jun. 30, 2020

Related U.S. Application Data
(60) Provisional application No. 62/613,228, filed on Jan. 3, 2018.

(30) Foreign Application Priority Data
Mar. 13, 2018 (EP) 18161570.9

(51) Int. Cl. G01S 7/497; G01S 17/04; H05B 47/13

(52) U.S. Cl. CPC G01S 7/497; H04L 67/12; H05B 47/13; G01S 17/04

(57) ABSTRACT

Disclosed are a system and method for improving the signal-to-noise ratio of sensors in a connected lighting system. At individual nodes of the system, sensor measurements are obtained during relatively quiescent time periods to model background noise. Collaboration between nodes is performed to yield a more accurate model of background noise. These noise models can then be used in de-noising subsequent sensor measurements.

### FIELD OF THE INVENTION

The present invention is directed to a connected light system and method for developing computational noise models using data acquired from sensors during relatively quiescent time periods and collaborating between nodes to improve noise models. These models are then used to reduce noise and/or improve the signal-to-noise ratio of the sensors by pre-processing data acquired from sensors of the lighting nodes.

### BACKGROUND OF THE INVENTION

Connected lighting systems will continue to be augmented with diverse sensors to enable optimal lighting control and applications beyond illumination. That is, the luminaires of such connected lighting systems comprise communication capabilities as well as various types of sensors—microphones, image-based sensors, thermopile arrays, and Time-of-Flight (ToF) sensors are just some of the examples. Further, such individual luminaires comprise processing capabilities to perform sensor data analysis as shall be described below. Background noise in these sensors reduces the quality of the signals and degrades the performance of downstream data analytics algorithms. Consequently, noise modelling will help in improving the signal quality and maximize the performance of machine learning algorithms that use this data.

Moreover, noise reduction is an ideal problem to be solved at the edge, i.e. inside and among the luminaires. As the sensor data is often affected by the occupancy of the space being monitored, noise can be modelled optimally when the luminaires detect no occupancy. In other words, quiescent periods, which are easily detected by luminaires, are ideal for modelling noise in the associated sensors.

In accordance with the principles of the invention, occupancy and motion sensors are present on a connected lighting system. Such systems are known in the prior art. By way of example, the lighting network systems described in U.S. Pat. No. 8,970,365 entitled “Evacuation System,” and in International Publication Number WO 2014/080040A2, entitled “Method and System for Evacuation Support;” both of which are hereby incorporated by reference in their entirety.

### SUMMARY OF THE INVENTION

The current invention provides a system and methods to perform noise modelling on sensors present in connected lighting systems using i) automated quiescent period detection, ii) Expectation Maximization (EM), and iii) collaboration among nodes to improve the noise models. EM, which is commonly used machine learning to optimize parameters, is executed in a novel distributed fashion across the luminaires. This guarantees spatial consistency of the models, catalogued by time of the day for which they are applicable, and quick convergence of the optimization procedures, which improves accuracy.

In one embodiment, Gaussian Mixture Models (GMM) are used to model the background noise. In particular, when a luminaire determines a no occupancy condition, it queries its neighbors for their GMM parameters. As defined herein neighbors relate to not only luminaires that are in physical proximity, but luminaires that are in a similar class or grouping. That is, luminaires positioned in a library may be defined as being in a class that is different than the class of luminaires in a cafeteria setting. Neighbors can be defined during the commissioning process upon installation of the luminaires.

Thus in various embodiments of the invention, upon a luminaire determining a no occupancy condition, the luminaire computes an initial guess of the GMM parameters using a weighted average of parameter values obtained from its neighbors. It should be noted that in additional embodiments of the invention, an initial guess for the parameters may also have been computed during the commissioning process. The assumption here is that the space is not yet occupied and therefore the sensors only measure background noise during this time. Once obtained, the GMM parameters are optimized using EM. Nodes placed in similar regions or usage, e.g., single-person offices, or those along similar noise regions such as cafeterias, high pedestrian traffic, are likely to experience similar background noise. Moreover, background noise is a non-stationary process, as it can change over time due to surrounding conditions. Due to the collaborative nature of processing, the noise models among the luminaires can be learned at different times of the day, as and when a quiescent period is detected. Such a feature is best enabled by intelligence at the edge, and collaboration among nodes, as shall be described in further detail below.

As used herein:

The term “quiescent period” is defined herein to be a period of relative inactivity. The terms “Luminaire” or “Intelligent Luminaire, is used herein to refer to an implementation or arrangement of one or more lighting units in a particular form factor, assembly, or package. As noted above, such luminaires comprise communication capabilities, a various types of sensors and data processing capabilities. The term “controller” is used herein generally to describe various apparatus relating to the operation of one or more Luminaires. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communication medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g. for device control, data storage, data exchange, etc.) between any two or more devices and/or among multiple devices coupled to the network. As noted above, individual luminaires can be regarded as nodes of such a network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1a illustrates the main elements of an embodiment of the current invention deployed in any exemplary office environment.

FIG. 1b illustrates an exemplary luminaire/node of the invention

FIG. 2 illustrates an exemplary modeling of sensor data derived by individual luminaires/nodes.

FIG. 3 illustrates a flow chart of the method employed in deriving noise models at a lighting node of the current invention.

### DETAILED DESCRIPTION OF THE EMBODIMENTS

It is to be understood that the figures and descriptions of the present invention described herein have been simplified to illustrate the elements that are relevant for a clear understanding of the present invention, while eliminating, for purposes of clarity only, many other elements. However, because these eliminated elements are well-known in the art, and because they do not facilitate a better understanding of the present invention, a discussion of such elements or the depiction of such elements is not provided herein. The disclosure herein is directed also to variations and modifications known to those skilled in the art.

It will be further understood that the present invention is described with regard to a specific implementation of a lighting system requiring light sources and luminaries. In the specific field of light management, occupancy sensors are sensing devices commonly connected to a room's lighting, which shut down these services when the space is unoccupied. However, it would be appreciated that other types of sensor devices can be employed without altering the scope of the invention.

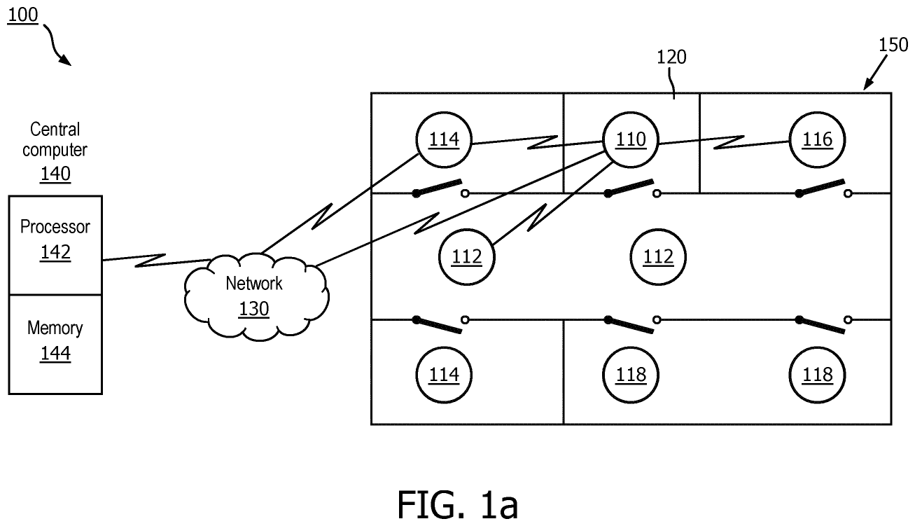

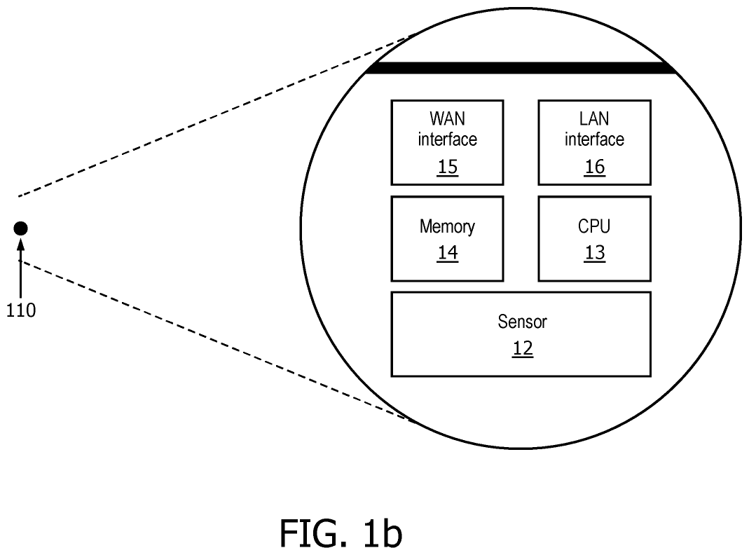

FIG. 1a illustrates an embodiment of the invention. In particular, the figure depicts the following elements of an exemplary system 100 situated in an office environment 150. As illustrated, various rooms and a hallway are provided with intelligent lighting system luminaires 110, 112, 114, 116, and 118, each containing one or more sensors and the ability to communicate directly with other luminaires, as well as to communicate over a network communication link 130. For the sake of simplification of the drawing, only a few of such communication paths are depicted.

FIG. 1b illustrates an exemplary node 110 in more detail (nodes 112, 114, 116, and 118 having similar features). The node comprises at least one sensor 12 (e.g., a PIR sensor, a GPS sensor, etc.). The data from the sensor 12 may be processed by a CPU 13 and/or stored in local memory 14. The node 10 can then send the information to, for example, other nodes 10 in a local area network (LAN) using a LAN interface 16, and/or to the network cloud 130 over the Wide Area network (WAN) using a WAN interface 15.

In an embodiment of the invention, each of the luminaire's sensors has the ability to sense the occupancy of the room (e.g., via a passive InfraRed sensor). Further embodiments envision having optional dedicated occupancy sensors which communicate with the room's luminaire. The system detects regions and times of low occupancy, characterized herein as quiescent periods. These regions and times are communicated over the network communication link(s) to a centralized computer system 140 which comprises a processor 142 and a memory 144.

In operation, a noise modelling method runs on luminaires in a region being measured to improve the signal-to-noise ratio of the luminaires' sensors. In doing so, the present invention exchanges model parameters to collaboratively optimize the noise models. Still further, the present invention is capable of inferring sets of nodes with similar contexts, where context can be defined by usage and/or location in the building (based on commissioning information). Still further, the present invention collaborates nodes having similar contexts to learn noise models for different times of the days.

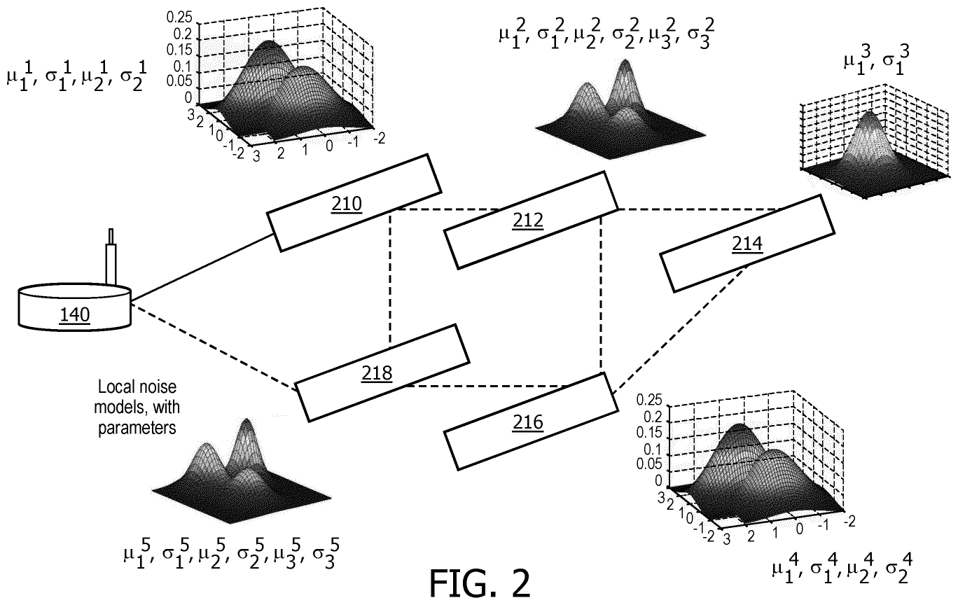

FIG. 2 illustrates GMM-based noise models determined at different sensor nodes (i.e., intelligent luminaires) of a connected lighting system. At node 210 a GMM distribution is graphically depicted. It is composed of different Gaussian distributions. Each of these distributions are fully determined by the respective mean and variance (\mu_1, \sigma_1) and (\mu_2, \sigma_2). Similarly, nodes 212-218 are illustrated depicting parameter distribution information.

The present invention has applications in improving various sensor measurements by collaborating between sensor nodes to thereby better model noise parameters. Consider the examples of imaging and audio sensors. Noise modelling is typically done using additive Gaussian Noise models. Specifically, Gaussian Mixture Models (GMMs) are the most commonly used noise model. GMM-based noised models have been used for audio signals to perform fall detection and imaging sensors to improve the quality of images. The signal S(x,y,t), where (x,y) denote the spatial variable and t denotes time, can be expressed as:

S(x,y,t)=f_{(x,y)}(t)+e(x,y,t),

where f_{(x,y)}(t) denotes the response of the sensor located at (x, y) at time t and e(x,y,t) denotes the noise in the signal. When this noise is modelled using GMMs, then it can be expressed as a random variable:

e(x,y,t)˜p(e_{x,y}|Θ_{x,y})=Σₖ₌₁^{K}αₖ^{x,y}pₖ^{x,y}(e_{x,y}|zₖ^{x,y},θₖ^{x,y}) (1)

In other words, the error is sampled from the distribution p(e_{x,y}|Θ_{x,y}), which is a combination of k Gaussian distributions: pₖ^{x,y}(e_{x,y}|zₖ^{x,y},θₖ^{x,y}). The vector z=[z₁, z₂, . . . zₖ, . . . ,zₖ] contains K binary indicator variables. If zₖ=1, all the other variables are 0 and the sample is selected from the k^{th} Gaussian, which has the parameters θₖ^{x,y}. The probability αₖ=prob(zₖ=1) is the probability of drawing from the k^{th} Gaussian: Σₖ₌₁^{K}αₖ=1.

Next, consider the example of Time-of-Flight (ToF) sensors. A typical construction of a ToF camera is described in a paper entitled “Noise characteristics of 3D time-of-flight cameras” by Dragos Fake and Vasile Buzuloiu, Arxiv, 2007; hereby incorporated by reference. A camera uses active illumination. The emitted light is then reflected by the objects in the scene and is sensed by a pixel array. The light reflected from far-away objects is attenuated more than the light reflected by nearby object.

In this paper, the authors consider an amplitude-modulated 20 MHz infrared illumination that lasts of 0.5-50 ms. Each pixel of the camera receives this incoming light and produces an electric signal proportional to the instantaneous value of the 20 MHz envelope. This signal is sampled four times per period: A₁, A₂, A₃, and A₄ denote the samples. These samples are the basis for calculating the amplitude α, from which the intensity image is obtained, and the phase shift ϕ, from which the distance image is computed. Specifically, they are calculated as follows:

$$φ = atan ( \frac{{A}_{4} - {A}_{2}}{{A}_{1} - {A}_{3}} )$$

$$a = \frac{\sqrt{{( {A}_{4} - {A}_{2} )}^{2} + {( {A}_{1} - {A}_{3} )}^{2}}}{2}$$

One possible way to model A₁-A₄ is as follows.

Aᵢ=gᵢ(eᵢ+nᵢ),i=1 . . . 4

The variable gᵢ denotes the gain of the receiver, eᵢ denotes the number of electrons produced in response to the incoming photons, and nᵢ is the additive Gaussian noise, which also can be modelled using a GMM.

As indicated in the above examples, Gaussian noise, specifically GMMs, are very useful in modelling noise and improving the signal-to-noise ratios. In various embodiments of the current invention, a system and method based on occupancy-sensor-enabled connected luminaires is used to estimate noise models and de-noise the signals acquired by lighting-based sensor systems.

In particular, connected lighting systems of the current invention can be employed to learn noise models and use them to improve the signal-to-noise ratio. This will improve the machine learning algorithms that process the signal data to enable different applications. Accordingly, problems frequently occurring in applications such as these based on microphones, cameras, ToF sensors, and thermopile arrays will be reduced.

For example, consider “Lighting-Related Usecases” where ToF sensors are used to detect the number of occupants, their pose, and their activity to provide contextual lighting. Improved noise modelling will boost the signal-to-noise ratio and reduce the errors in the machine learning algorithms that enable occupant counting, pose estimation and activity recognition. Additionally, consider the usecase of microphones when used in outdoor environments for gun-shot detection. Traffic sensors or historical traffic patterns, when modelled with respect to quiescent periods, are ideal to learn noise models to filter subsequently detected audio signals to reduce false positives in gunshot detection.

In one embodiment of the invention, Expectation-Maximization (EM) is utilized. Each node optimizes the parameters of its noise model using EM and initial guesses based on its neighbor's model. This encourages quick convergence and also spatial continuity across a given space.

It should be noted that while the discussion below relates to EM and GMM modelling, the invention is not so limited. That is, other noise models and techniques to learn the model parameters are contemplated by the invention's collaboration process between multiple nodes.

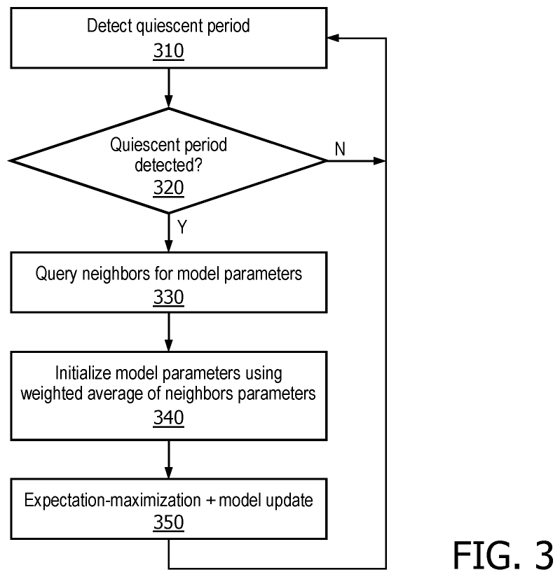

FIG. 3 illustrates the algorithm that each lighting node of the connected lighting system runs according to one embodiment of the invention. Each node monitors the occupancy sensor and waits for a quiescent period (Steps 310-320). In an office environment, these are periods of no occupancy and thus are ideal for modelling background noise. This could be when a meeting room is empty, or during night times, when the office is not occupied.

When a quiescent period is detected, the noise modelling routines commence. That is, at step 330, the optimization parameters are initialized, based on the noise models from the neighbors. In on embodiment the node queries its neighbors directly for their model parameters. In alternative embodiments, some or all of these parameters may be obtained through communication with the central computer 140.

Let the complete set of parameters at a given node, which is located at (x,y) be given by

Θ_{x,y}={α₁^{x,y}, . . . ,α_{K}^{x,y},θ₁^{x,y}, . . . ,θₖ^{x,y}}.

Given these values from the neighbors, the node computes a weighted average of all the parameter vectors to get its initial estimate.

The current invention initially assumes that the data collected by the sensors during a quiescent period must be due to background noise. Thus, all the data accumulated during this time period is used for noise modelling. Given that there are M data points, e₁, e₂, . . . , e_{M}, step 350 performs the following operations:

Expectation step: For each data point, the node computes the membership weights, wᵢₖ which is the posterior probability of the k^{th} Gaussian model having been the source of the point. Then, using Bayes rule,

$${w}_{ik} = prob ( {z}_{ik} = 1 \vert {e}_{i} , Θ ) = \frac{p * ( {e}_{i} \vert {z}_{k} , {θ}_{k} ) {α}_{k}}{{\sum }_{j = 1}^{K} {p}_{j} ( {e}_{i} \vert {z}_{j} , {θ}_{j} ) {α}_{j}} , \\ 1 \leq k \leq K , 1 \leq i \leq M$$

The membership weight is calculated for each data point and for each component of the GMM model.

Maximization step: The parameters of the GMM are then calculated as follows.

$${α}_{k}^{new} = \frac{{N}_{k}}{M} ,$$

where Nₖ is the number of data points that were assigned to the k^{th} component. Similarly, the mean of each Gaussian component can be computed as:

$${μ}_{k} = \frac{1}{{N}_{k}} {\sum }_{i = 1}^{M} {w}_{i k} {e}_{i}$$

$${σ}_{k} = \frac{1}{{N}_{k}} {\sum }_{i = 1}^{M} {{w}_{k} ( {e}_{i} - {μ}_{k} )}^{2}$$

Step 350 is then repeated until convergence. That is, the expectation and maximization steps are repeated until changes occurring to the values of α, μ and σ are less than a pre-defined threshold.

In additional embodiments of the invention, the nodes can also time-stamp or catalogue the noise models based on the time when they were learned. The nodes located in similar spaces (for example in an elevator lobby) can collaboratively learn a library of noise models. They can also share the most appropriate parameters to be used at different times of the day. For example, one set of nodes with similar contexts can have a library of noise models for different times of the day. Such models may be stored at a central computer, like the gateway. The above EM approach may be repeated periodically during times a node of one particular context detects a quiescent period. In additional embodiments, the calculations may be event triggered.

Once the noise models are learned, nodes of similar context can use noise models from the library, even if they have not been learned by the node alone. Such collaborate learning and deployment of noise models can improve signal to noise ratio for all sensors.

In summary the current invention improves the signal-to-noise ratio of sensors in a connected lighting system. Sensor measurements are obtained during quiescent time periods to thereby effectively model background noise. These noise models can then be used in de-noising subsequent sensor measurements.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although, a computer, a processor and/or dedicated hardware/software are described herein as being capable of processing the processing described herein, it would be recognized that a computer, a processor and/or dedicated hardware/software are well-known elements in the art of signal processing and, thus, a detailed description of the elements of the processor need not provided in order for one skilled in the art to practice the invention described, herein.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage.

The term “comprises”, “comprising”, “includes”, “including”, “as”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “or”. For example, a condition A or B is satisfied by any one of the following: A is true (or present) and B is false (or not present); A is false (or not present) and B is true (or present); and both A and B are true (or present).

While there has been shown, described, and pointed out fundamental and novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

Any reference signs in the claims should not be construed as limiting the scope of the claims or the invention described by the subject matter claimed.

1. A system for modelling noise of sensor data obtained from sensors associated with intelligent luminaires, the system comprising:
a plurality of luminaires and a plurality of sensors, each of the plurality of sensors in communication with at least one luminaire;
each of said plurality of luminaires being configured to communicate with at least one other luminaire to form a network;
each luminaire being configured to monitor, through its corresponding sensor, a region to thereby determine a period of relative inactivity in the region;
each luminaire comprising a processor such that periodically, upon a particular luminaire determining such a period of relative inactivity in the region, the luminaire performs the following operations:
obtains a neighbor luminaire's noise model parameters for at least one neighbor luminaire, wherein the neighbor luminaire is at least one of in physical proximity to the particular luminaire and belongs to a same classification as the particular luminaire,
computes a weighted average of the obtained noise model parameters of the neighbor luminaire as an initial estimate of the noise model parameters for the particular luminaire,
determines the noise model parameters for the particular luminaire by recursively performing an expectation step and a maximization step.

2. The system of claim 1 wherein the particular luminaire is designated as the k^{th} node, and wherein the expectation step comprises for each data point, e₁, e₂, . . . , e_{M}, the k^{th} node computes membership weights, wᵢₖ in the following manner:
$${w}_{ik} = prob ( {z}_{ik} = 1 \vert {e}_{i} , Θ ) = \frac{{p}_{k} ( {e}_{i} \vert {z}_{k} , {θ}_{k} ) {α}_{k}}{{\sum }_{j = 1}^{K} {p}_{j} ( {e}_{i} \vert {z}_{j} , {θ}_{j} ) {α}_{j}} , \\ 1 \leq k \leq K , 1 \leq i \leq M ;$$
where the complete set of parameters at a given node, which is located at (x,y) be given by Θ={α₁, . . . , α_{K}, θ₁, . . . , θ_{K}};
and wherein the membership weight is calculated for each data point and for each component of the noise model.

3. The system of claim 2 wherein the noise model is a Gaussian Mixture Model, GMM, and the maximization step comprises calculating the parameters of the GMM as follows:
$${μ}_{k} = \frac{1}{{N}_{k}} {\sum }_{i = 1}^{M} {w}_{i k} {e}_{i}$$
$${σ}_{k} = \frac{1}{{N}_{k}} {\sum }_{i = 1}^{M} {{w}_{ik} ( {e}_{i} - {μ}_{k} )}^{2}$$
where
$${α}_{k}^{new} = \frac{{N}_{k}}{M} ,$$
where Nₖ is the number of data points that are assigned to the k^{th} component.

4. The system of claim 3 wherein the calculations of wᵢₖ, μₖ and σₖ are repeated until changes of the values of μₖ and σₖ occur within a pre-defined threshold.

5. The system of claim 1 wherein at least some of the neighbor's model parameters are obtained directly from a neighbor luminaire.

6. The system of claim 1 wherein at least some of the neighbor's model parameters are obtained from a central processor on the network.

7. The system of claim 1 wherein at least some of the neighbor's model parameters were derived during commissioning of the luminaire.

8. The system of claim 1 further comprising an occupancy detector functionality for use in determining the period of relative inactivity in the region.

9. The system of claim 1 further comprising collaboration between luminaires to develop noise models for different times of the day.

10. A method for modelling noise of sensor data obtained from sensors associated with a plurality of intelligent luminaires, wherein each of said plurality of luminaires being configured to communicate with at least one other luminaire to form a network; the method comprising:
monitoring a region to thereby determine a period of relative inactivity in the region in the region;
upon determining by a particular luminaire such a period of relative inactivity in the region, the luminaire performing the following operations:
obtaining a neighbor luminaire's noise model parameters for at least one neighbor luminaire, wherein the neighbor luminaire is at least one of in physical proximity to the particular luminaire and belongs to a same classification as the particular luminaire,
computing a weighted average of the obtained noise model parameters of the neighbor luminaire as an initial estimate of the noise model parameters for the particular luminaire,
determining the noise model parameters for the particular luminaire by recursively performing an expectation step and a maximization step.

11. The method of claim 10 wherein the particular luminaire is designated as the k^{th} node, and wherein the statistical operations comprise an expectation step, which comprises for each data point, e₁, e₂, . . . , e_{M}, the k^{th} node computing membership weights, wᵢₖ in the following manner:
$${w}_{ik} = prob ( {z}_{ik} = 1 \vert {e}_{i} , Θ ) = \frac{{p}_{k} ( {e}_{i} \vert {z}_{k} , {θ}_{k} ) {α}_{k}}{{\sum }_{j = 1}^{K} {p}_{j} ( {e}_{i} \vert {z}_{j} , {θ}_{j} ) {α}_{j}} , \\ 1 \leq k \leq K , 1 \leq i \leq M ;$$
where the complete set of parameters at a given node, which is located at (x,y) be given by
Θ={α₁, . . . ,α_{K},θ₁, . . . ,θ_{K}};
and wherein the membership weight is calculated for each data point and for each component of the noise model.

12. The method of claim 11 wherein the noise model is a Gaussian Mixture Model, GMM, and the statistical operations comprise a maximization step which comprises calculating the parameters of the GMM as follows:
$${μ}_{k} = \frac{1}{{N}_{k}} {\sum }_{i = 1}^{M} {w}_{i k} {e}_{i}$$
$${σ}_{k} = \frac{1}{{N}_{k}} {\sum }_{i = 1}^{M} {{w}_{ik} ( {e}_{i} - {μ}_{k} )}^{2}$$
where
$${α}_{k}^{new} = \frac{{N}_{k}}{M} ,$$
where Nₖ is the number of data points that are assigned to the k^{th} component.

13. The method of claim 12 wherein the calculations of wᵢₖ, μₖ and σₖ are repeated until changes of the values of μₖ and σₖ occur within a pre-defined threshold.

14. The method of claim 10 further comprising collaboration between luminaires to develop noise models for different times of the day.

15. A computer program product comprising a plurality of program code portions, stored in a non-transitory computer readable medium, for carrying out the method according to claim 10.
